(19) United States
(12) Patent Application Publication
(10) Pub. No.: US 2026/0004390 A1
(43) Pub. Date: Jan. 1, 2026

(54) REDUCING DISTORTION IN A FOVEATED RESOLUTION DISPLAY

(71) Applicant: Meta Platforms Technologies, LLC, Menlo Park, CA (US)

(72) Inventors: Misael Perez Martinez, Kirkland, WA (US); Eun Sung Huh, Menlo Park, CA (US); Byung Geun Jun, Santa Clara, CA (US); Semin Koong, Goyang-si (KR); Joonggun Lee, Los Gatos, CA (US)

(21) Appl. No.: 18/991,155

(22) Filed: Dec. 20, 2024

Related U.S. Application Data
(60) Provisional application No. 63/665,039, filed on Jun. 27, 2024.

(51) Int. Cl. G06T 3/4023; G06F 3/01; G06T 5/70; G06T 5/80; G09G 3/36

(52) U.S. Cl. CPC G06T 3/4023; G06T 5/70; G06T 5/80; G06F 3/013; G09G 3/3674; G09G 2320/0233; G09G 2320/0242; G09G 2340/0407; G09G 2354/00

(57) ABSTRACT

Methods, systems, and storage media for reducing distortion in a foveated resolution display (FRD) are disclosed. Exemplary implementations may: implement a pixel duplication for a select region of a display; implement a horizontal upscaling and a vertical upscaling through the grouped gate scan (GGS); implement a chromatic aberration correction (CAC) to the select region; in response to the CAC, implement a horizontal up-scale of the select region and a vertical up-scale of the select region; and implement a Mura compensation to the select region.

### CROSS RELATED APPLICATIONS

The present disclosure is related and claims priority under 35 U.S.C. 119 (e) to U.S. Provisional Patent Application No. 63/665,039 filed on Jun. 27, 2024, the disclosure of which is hereby incorporated by reference in its entirety for all purposes.

### TECHNICAL FIELD

The present disclosure generally relates to display technologies, and more particularly to reducing distortion in a foveated resolution display (FRD).

### BACKGROUND

In the field of mixed reality, the visual experience is a critical aspect of user immersion and interaction. Foveated rendering is a technique that may prioritize rendering quality in the area of the user's gaze focus, typically the center of the visual field, while reducing the quality in the periphery. This approach may leverage the human visual system's varying acuity to optimize processing resources. Display driver integrated circuits (DDICs) may assume full resolution across the entire display. In the field of mixed reality, users may interact with simulated environments that can replicate real-world or fantastical scenarios. These simulated environments may include a variety of objects with different textures and shapes, aiming to provide an immersive experience. The visual realism in such settings may be crucial for applications spanning entertainment, military, medical, and process manufacturing simulations.

### BRIEF SUMMARY

The subject disclosure provides for systems and methods for display technologies. A user is allowed to experience a higher quality visual output with reduced distortion in specific regions of the display. For example, the implementation of pixel duplication, upscaling, chromatic aberration correction, and Mura compensation ensures that the select region of the display maintains clarity and color accuracy, enhancing the overall viewing experience.

One aspect of the present disclosure relates to a method for reducing distortion in an FRD. The method may include implementing a pixel duplication for a select region of a display. The method may include implementing a horizontal upscaling and a vertical upscaling through the grouped gate scan (GGS). The method may include implementing a chromatic aberration correction (CAC) to the select region. The method may include, in response to the CAC, implementing a horizontal up-scale of the select region and a vertical up-scale of the select region. The method may include implementing a Mura compensation to the select region.

Another aspect of the present disclosure relates to a system configured to reduce distortion in an FRD. The system may include a non-transient computer-readable storage medium having executable instructions embodied thereon. The system may include one or more hardware processors configured to execute the instructions. The processor(s) may execute the instructions to implement a pixel duplication for a select region of a display. The processor(s) may execute the instructions to implement a horizontal upscaling and a vertical upscaling through the grouped gate scan (GGS). The processor(s) may execute the instructions to implement a chromatic aberration correction (CAC) to the select region. The processor(s) may execute the instructions to, in response to the CAC, implement a horizontal up-scale of the select region and a vertical up-scale of the select region. The processor(s) may execute the instructions to implement a Mura compensation to the select region.

Yet aspect of the present disclosure relates to a system configured to reduce distortion in an FRD. The system may include means for implementing a pixel duplication for a select region of a display. The system may include means for implementing a horizontal upscaling and a vertical upscaling through the grouped gate scan (GGS). The system may include means for implementing a chromatic aberration correction (CAC) to the select region. The system may include means for, in response to the CAC, implementing a horizontal up-scale of the select region and a vertical up-scale of the select region. The system may include means for implementing a Mura compensation to the select region.

Still another aspect of the present disclosure relates to a non-transient computer-readable storage medium having instructions embodied thereon, the instructions being executable by one or more processors to perform a method for reducing distortion in an FRD. The method may include implementing a pixel duplication for a select region of a display. The method may include implementing a horizontal upscaling and a vertical upscaling through the grouped gate scan (GGS). The method may include implementing a chromatic aberration correction (CAC) to the select region. The method may include, in response to the CAC, implementing a horizontal up-scale of the select region and a vertical up-scale of the select region. The method may include implementing a Mura compensation to the select region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The patent or application file contains at least one drawing executed in color. Copies of this patent or patent application publication with color drawing(s) will be provided by the Office upon request and payment of the necessary fee.

FIG. 1 is a block diagram illustrating an overview of an environment in which some implementations of the disclosed technology can operate.

FIG. 2 illustrates a foveated rendering display which supports techniques for reducing distortion in an FRD, in accordance with one or more implementations.

FIG. 3 illustrates a foveated rendering display which supports techniques for reducing distortion in an FRD, in accordance with one or more implementations.

FIG. 4 illustrates a distortion correction diagram which supports techniques for reducing distortion in an FRD, in accordance with one or more implementations.

FIG. 5 illustrates a distortion resolution diagram which supports techniques for reducing distortion in an FRD, in accordance with one or more implementations.

FIG. 6 illustrates a data path diagram which supports techniques for reducing distortion in an FRD, in accordance with one or more implementations.

FIG. 7 illustrates a data path diagram which supports techniques for reducing distortion in an FRD, in accordance with one or more implementations.

FIG. 8 illustrates a distortion resolution diagram which supports techniques for reducing distortion in an FRD, in accordance with one or more implementations.

FIG. 9 illustrates distortion comparison images which supports techniques for reducing distortion in an FRD, in accordance with one or more implementations.

FIG. 10 illustrates distortion comparison images which supports techniques for reducing distortion in an FRD, in accordance with one or more implementations.

FIG. 11 illustrates distortion comparison images which supports techniques for reducing distortion in an FRD, in accordance with one or more implementations.

FIG. 12 illustrates a gain remapping diagram which supports techniques for reducing distortion in an FRD, in accordance with one or more implementations.

FIG. 13 illustrates a system configured for reducing distortion in an FRD, in accordance with one or more implementations.

FIG. 14 illustrates an example flow diagram for reducing distortion in an FRD, according to certain aspects of the disclosure.

FIG. 15 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can sec. The AR headset may be a block-light headset with video pass-through. “Mixed reality” or “MR,” as used herein, refers to any of VR, AR, XR, or any combination or hybrid thereof.

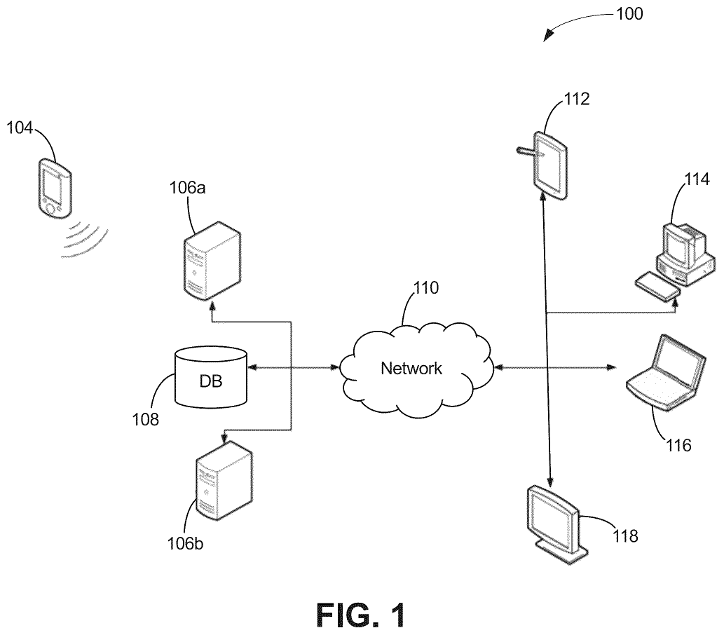

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

In some examples, the integration of foveated rendering with existing image quality algorithms may pose a significant challenge. When a display driver integrated circuit supports FRD, it may typically conduct pixel duplication and horizontal upscaling, while panels may perform vertical upscaling through a process known as grouped gate scan or GGS. However, since display driver integrated circuits may internally handle only half of the total vertical lines, this may result in distortions when combined with image quality algorithms like chromatic aberration correction (CAC) and Mura compensation, which are not designed to accommodate the resolution discrepancies inherent in foveated rendering. The upscaling and downscaling required by CAC, for instance, may lead to band migration and image distortion between the foveated and non-foveated regions. Similarly, Mura compensation algorithms, which may smooth out variations in display uniformity, may not align correctly with the physical location of upscaled video data, further degrading image quality.

The subject disclosure provides for systems and methods for display technologies. A user is allowed to experience a higher quality visual output with reduced distortion in specific regions of the display. For example, the implementation of pixel duplication, upscaling, chromatic aberration correction, and Mura compensation ensures that the select region of the display maintains clarity and color accuracy, enhancing the overall viewing experience.

Implementations described herein address the aforementioned shortcomings and other shortcomings by providing a method that may seamlessly integrate foveated rendering with image quality algorithms, thereby reducing image distortion in foveated resolution displays. One aspect of the solution may lie in a CAC, which may now be equipped with both vertical-scale up and line selector functionalities. This enhancement may allow for precise control over the scaling process, ensuring that the foveated region may be rendered with high fidelity while maintaining the integrity of the image quality algorithms.

Furthermore, the method may include the addition of a vertical line duplication block specifically designed for GGS equal to 2. This block may be strategically placed before the writing path of CAC memories. With this configuration, the system may selectively discard lines during the upscaling or downscaling process when foveated rendering display is activated. This selective line discard capability may be crucial for preventing the band migration and image distortion that typically occur when transitioning between foveated and non-foveated regions. By implementing these targeted modifications, some implementations may ensure that the foveated rendering display not only optimizes processing resources but also delivers a distortion-free visual experience, thereby enhancing the overall realism and immersion in mixed reality environments.

According to some implementations, some implementations may include a method for reducing image distortion in an FRD, which may be particularly relevant in mixed reality environments where realism and immersion can be critical. The method involves several features and components that work in tandem to address the technical problem of distortion caused by multiple image quality algorithms during rendering.

For example, the method may include implementing pixel duplication for a select region of the display. This process may involve duplicating pixels in a specific area, which is particularly relevant when the display driver integrated circuit (DDIC) supports FRD. Pixel duplication may facilitate managing the resolution and quality of the displayed image.

The method may incorporate horizontal upscaling and vertical upscaling through the GGS. The DDIC may conduct horizontal upscaling, while panels may perform vertical upscaling through GGS. This upscaling may facilitate converting the half total vertical lines that the DDIC internally has into a full-resolution image.

The method may implement chromatic aberration correction to the select region. CAC is an algorithm that corrects the color distortion caused by lens aberration, typically involving the upscaling of red color and downscaling of blue color. This correction may facilitate maintaining the color fidelity of the image.

The method may include the inclusion of a CAC that integrates both vertical-scale up (V-up) and line selector functionalities. The CAC may be configured to handle the vertical scaling of the image and select specific lines for processing, which may facilitate managing the distortion that can occur when FRD is enabled.

The method may add a vertical line duplication block for GGS=2 separately before the writing path of CAC memories. This block may be responsible for duplicating vertical lines, which can be necessary when the GGS is set to 2, indicating that each input line is duplicated once to expand the image vertically.

The CAC scaler may be capable of conducting line discard during the upscaling or downscaling process for CAC if FRD is activated. This functionality may allow the system to discard certain lines to prevent distortion, ensuring that the image quality is maintained when the resolution is adjusted.

The method may ensure that a vertically up-scaled image in CAC memory does not create any distortion when FRD is enabled. This feature may facilitate preserving the integrity of the image during the rendering process.

The method may include the addition of a vertical line selector, which may be set to even or odd, to support fine-tuning of the image. This selector may be used to choose between even or odd lines for processing, which may facilitate managing the image quality and reducing distortion.

The method may include Mura compensation to support a line selector based on FRD boundary information when FRD is enabled with smoothing. Mura compensation may include an algorithm used to even out the luminance across the display. The line selector may help in choosing the appropriate lines for compensation, ensuring that the smoothing is applied correctly without introducing distortion.

The Mura compensation may include smoothing options such as selecting even lines, odd lines, or averaging between lines. These options may be part of the compensation process to ensure that each pixel receives the correct gain or offset, which may facilitate reducing visual artifacts and maintaining image uniformity.

These features collectively may contribute to the method's ability to reduce image distortion in an FRD, particularly when dealing with the complexities introduced by FRD and the need to manage various image quality algorithms effectively. The method's design may be focused on minimizing internal memory requirements while ensuring that the rendered image is free from distortion, thereby enhancing the user's immersive experience in a mixed reality environment.

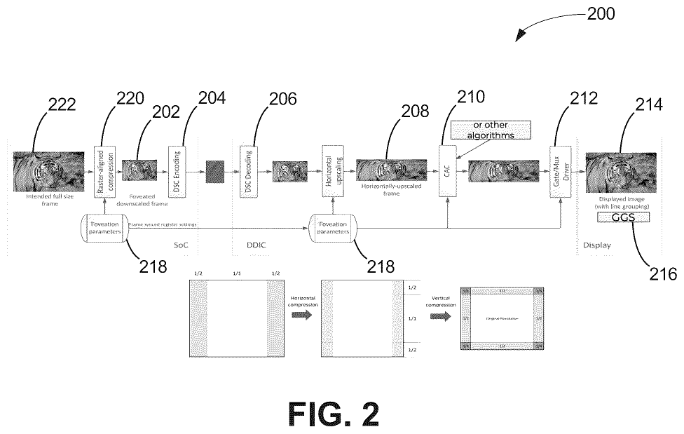

FIG. 2 shows a foveated rendering display 200 which supports techniques for reducing distortion in an FRD in accordance with various aspects of the present disclosure. As depicted in FIG. 2, the foveated rendering display 200 may include one or more of a foveated downscaled frame 202, a display stream compression (DSC) encoding 204, a DSC decoding 206, a horizontally-upscaled frame 208, a CAC 210, a gate/mux driver 212, a displayed image 214, a GGS 216, a foveation parameter 218, a raster-aligned compression 220, a full-size frame 222, and/or other components.

The foveated downscaled frame 202 may represent a reduced resolution image that targets the user's focal area within the display. In some implementations, the foveated downscaled frame 202 may be generated by selectively reducing the resolution of the image data corresponding to the peripheral vision of the user. The foveated downscaled frame 202 may be created to allocate more detail to the area where the user is most likely to focus. The foveated downscaled frame 202 may interact with the DSC encoding 204 to compress the image data efficiently. An example of the foveated downscaled frame 202 may include a lower resolution image of a virtual environment where the peripheral areas are less detailed than the center.

The DSC encoding 204 may compress the image data to facilitate efficient transmission across system components. In some implementations, the DSC encoding 204 may apply a compression algorithm to reduce the amount of data that needs to be transmitted. The DSC encoding 204 may work in conjunction with the DSC decoding 206 to ensure that the image data is compressed and decompressed without significant loss of information. The DSC encoding 204 may be part of a pipeline that includes the foveated downscaled frame 202 and the DSC decoding 206. An example of the DSC encoding 204 may be a software module that applies lossless compression to image data before it is sent to another component for further processing.

The DSC decoding 206 may reconstruct the original image data from the compressed format provided by the DSC encoding 204. In some implementations, the DSC decoding 206 may reverse the compression applied by the DSC encoding 204 to restore the image data to a state suitable for display. The DSC decoding 206 may be responsible for ensuring that the image data is accurately reconstructed after transmission. The DSC decoding 206 may receive compressed data from the DSC encoding 204 and prepare it for upscaling by the horizontally-upscaled frame 208. An example of the DSC decoding 206 may be a hardware decoder that is specialized in decompressing data encoded by the DSC encoding 204.

The horizontally-upscaled frame 208 may increase the horizontal resolution of the image to match the display's native resolution. In some implementations, the horizontally-upscaled frame 208 may expand the width of the image data to fill the display screen without distortion. The horizontally-upscaled frame 208 may adjust the image data after it has been decompressed by the DSC decoding 206. The horizontally-upscaled frame 208 may be followed by the CAC 210 in the processing pipeline. An example of the horizontally-upscaled frame 208 may be a processing step that scales up the width of a video frame to fit a widescreen display format.

The CAC 210 may adjust the image to correct for chromatic aberrations introduced by lens distortions. In some implementations, the CAC 210 may modify the color channels of the image to align them correctly on the display. The CAC 210 may be necessary to compensate for the color fringing that can occur when light passes through lenses. The CAC 210 may process the image data after it has been horizontally upscaled by the horizontally-upscaled frame 208. An example of the CAC 210 may be a set of digital filters that adjust the red, green, and blue components of an image to prevent color bleeding.

The gate/mux driver 212 may control the timing and delivery of image data to the display's pixels. In some implementations, the gate/mux driver 212 may synchronize the flow of image data with the display's refresh rate. The gate/mux driver 212 may ensure that each pixel receives the correct data at the right time. The gate/mux driver 212 may operate in coordination with the displayed image 214 to present the final image to the user. An example of the gate/mux driver 212 may be an integrated circuit that directs image data to specific rows and columns of a liquid crystal display.

The displayed image 214 may represent the final visual output as seen by the user after all processing has been applied. In some implementations, the displayed image 214 may be the result of various image processing techniques that enhance the visual experience. The displayed image 214 may be the culmination of the image data processed by components such as the CAC 210 and the gate/mux driver 212. The displayed image 214 may be what the user ultimately perceives when using the mixed reality system. An example of the displayed image 214 may be the immersive scenery of a virtual world as experienced through a VR headset.

The GGS 216 may perform vertical upscaling of the image by grouping and scanning gate lines in the display. In some implementations, the GGS 216 may duplicate certain lines of the image to increase its vertical size. The GGS 216 may be involved in adjusting the image data to fit the aspect ratio of the display. The GGS 216 may work after the displayed image 214 has been processed by the gate/mux driver 212. An example of the GGS 216 may be a technique used in OLED displays to double the number of vertical lines for a more detailed image.

The foveation parameter 218 may dictate the region of the display that is rendered at higher resolution based on the user's gaze. In some implementations, the foveation parameter 218 may be adjusted dynamically as the user's gaze shifts across the display. The foveation parameter 218 may determine how the foveated downscaled frame 202 is generated. The foveation parameter 218 may be influenced by eye-tracking data to provide a personalized viewing experience. An example of the foveation parameter 218 may be a set of values that define the size and position of the high-resolution area in a foveated rendering system.

The raster-aligned compression 220 may reduce the image data size in a manner that aligns with the display's raster scan. In some implementations, the raster-aligned compression 220 may compress the image data in a way that matches the scanning pattern of the display. The raster-aligned compression 220 may help in reducing the bandwidth required for transmitting the image data. The raster-aligned compression 220 may be applied before the image data reaches the full-size frame 222. An example of the raster-aligned compression 220 may be a compression scheme that considers the horizontal and vertical sync signals of a display.

The full-size frame 222 may represent the complete image data at the display's native resolution before any foveated rendering techniques are applied. In some implementations, the full-size frame 222 may serve as a reference for the final image quality. The full-size frame 222 may be used to compare the effectiveness of the foveation.

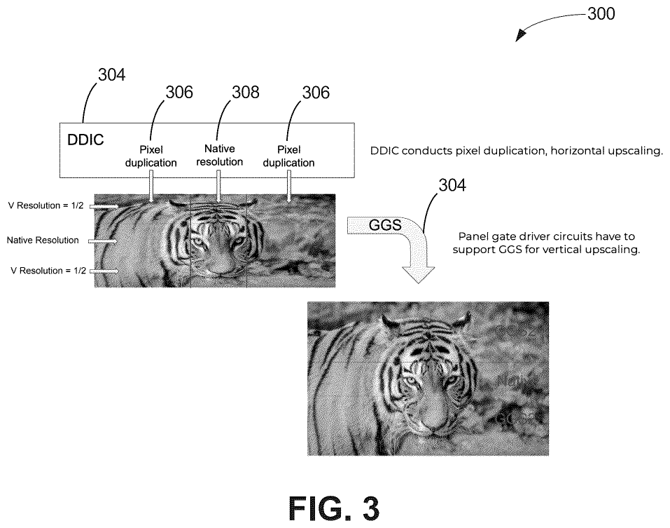

FIG. 3 shows a foveated rendering display 300 which supports techniques for reducing distortion in an FRD in accordance with various aspects of the present disclosure. As depicted in FIG. 3, the foveated rendering display 300 may include one or more of a DDIC 302, a GGS 304, a pixel duplication 306, a native resolution 308, and/or other components.

The DDIC 302 may be responsible for managing the display data and preparing it for rendering on the panel. The DDIC 302 may serve as a control unit for the foveated rendering display 300. The DDIC 302 may process incoming video data for output to the panel. The DDIC 302 may interface with other components to synchronize the rendering process. In some implementations, the DDIC 302 may be an integrated circuit specifically designed for display management.

The GGS 304 may provide a method for vertical upscaling within the foveated rendering display 300. The GGS 304 may be involved in increasing the vertical resolution of an image. The GGS 304 may function by duplicating lines of pixels to achieve the desired upscaling effect. The GGS 304 may work in conjunction with the DDIC 302 to manage the vertical scaling of display data. In some implementations, the GGS 304 may be a technique applied to the panel to enhance the perceived image resolution.

The pixel duplication 306 may be involved in the process of increasing the pixel count in certain regions of the display. The pixel duplication 306 may duplicate pixels to create a higher density of pixels in specific areas. The pixel duplication 306 may be used to maintain visual fidelity in areas of the display where higher resolution is desired. The pixel duplication 306 may be controlled by the DDIC 302 to target specific regions for enhanced detail. In some implementations, the pixel duplication 306 may be a method used to artificially enhance the resolution without altering the native content.

The native resolution 308 may represent the original resolution of the content before any foveated rendering techniques are applied. The native resolution 308 may be the baseline resolution from which the foveated rendering techniques begin their modifications, wherein the native resolution comprises a plurality of native pixels. The native resolution 308 may be maintained in the central area of the display where the user's focus is directed. The native resolution 308 may be surrounded by areas that have undergone pixel duplication 306 and upscaling by the GGS 304. In some implementations, the native resolution 308 may be the highest quality portion of the display output.

In some implementations, the DDIC 302 may conduct pixel duplication 306 and horizontal upscaling before sending the data to a panel. The GGS 304 may then perform vertical upscaling on the panel to achieve the final display output. Chromatic aberration correction may be applied to the upscaled image to correct any color distortions. Mura compensation may adjust the uniformity of the upscaled image to ensure consistent brightness and color. A smoothing algorithm may blend the boundaries between different resolution zones to create a seamless visual transition. A partial frame memory may temporarily store sections of the display data during the rendering process. A digital gamma may adjust the luminance levels of the final image before it is rendered on the panel.

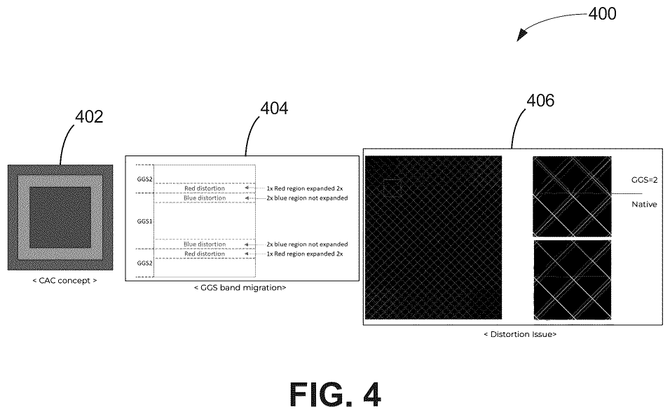

FIG. 4 shows a distortion correction diagram 400 which supports techniques for reducing distortion in an FRD in accordance with various aspects of the present disclosure. As depicted in FIG. 4, the distortion correction diagram 400 may include one or more of a CAC 402, a GGS 404, a Mura compensation 406, and/or other components.

The CAC 402 may perform adjustments to color channels to correct for chromatic aberration. The CAC 402 may scale the red and blue channels of the video data to align them properly on the display, ensuring that colors are accurately represented.

The GGS 404 may control the vertical scaling of the display. The GGS 404 may duplicates lines of video data to match the display's vertical resolution requirements, playing a crucial role in the vertical duplication of lines as part of the foveated rendering process.

The Mura compensation 406 may adjust the brightness and color uniformity across the display. The Mura compensation 406 may apply corrections to different blocks of the display to reduce visual imperfections, enhancing the overall visual quality of the display.

In operation, the CAC 402 may receive downscaled images and performs horizontal upscaling on the images. The GGS 404 then may perform vertical scaling on the selected lines. The CAC 402 may further perform chromatic aberration correction on the scaled lines. Finally, the Mura compensation 406 may adjust the brightness and color uniformity of the lines, ensuring a high-quality visual output on the display.

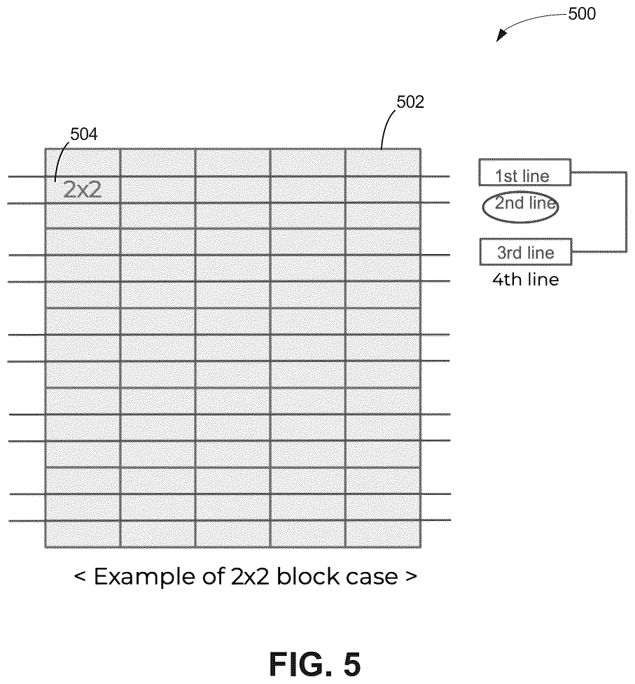

FIG. 5 shows a distortion resolution diagram 500 for determining an optimal data path to resolve distortion between algorithms in accordance with various aspects of the present disclosure. As depicted in FIG. 5, the distortion resolution diagram 500 may include one or more of a display grid 502, a 2×2 block 504, and/or other components. The 1st line, 2nd line, 3rd line, and 4th line may include adjacent horizontal lines of the 2×2 block 504.

The display grid 502 may represent a section of the display where image processing is applied. In some implementations, the display grid 502 may be used to group pixels for processing in an FRD. The display grid 502 may be involved in the application of image quality algorithms. The display grid 502 may be part of a larger grid that constitutes the display area. For example, the display grid 502 may be one of many grids that are processed in parallel to render an image.

The 2×2 block 504 may represent a smaller section within the display grid 502 where detailed image processing occurs. In some implementations, the 2×2 block 504 may be used to manage pixel data for reducing distortion. The 2×2 block 504 may be involved in the application of specific image quality algorithms to ensure optimal rendering. The 2×2 block 504 may be processed in a manner that skips certain lines to achieve the desired image quality.

To prevent distortion between algorithms, conventional architectures may exploit a partial frame memory to reconstruct original images. This approach may not have distortion issues from downscaled images by FRD, although it may require large amounts of memory. The methodology described in FIG. 5 may provide an optimal data path that avoids the need for such extensive memory usage.

In some implementations, the 1st line, 2nd line, 3rd line, and 4th line within the 2×2 block 504 may be processed in a sequence that skips certain lines to reduce distortion. For example, the data path may go from the 1st line to the 3rd line, skipping the 2nd line, to achieve the desired image quality. This method may help in maintaining the integrity of the image while minimizing the memory requirements.

The described methodology may ensure that the image data is processed efficiently, reducing the likelihood of distortion and improving the overall quality of the rendered image. By optimizing the data path and selectively processing lines within the 2×2 block 504, the system may achieve high-quality image rendering with reduced memory usage.

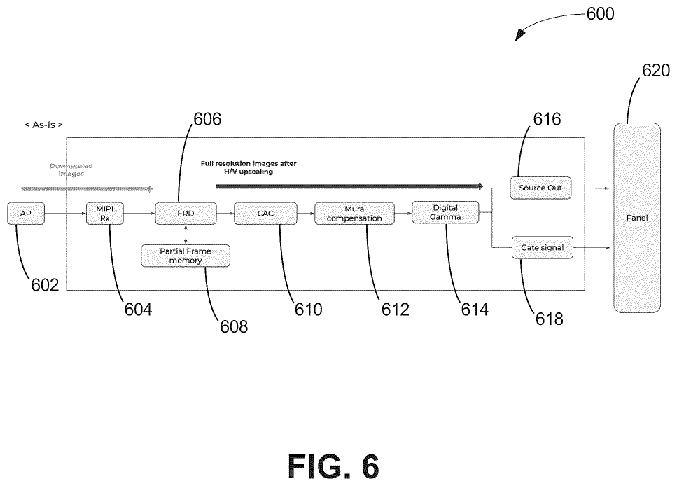

FIG. 6 shows a data path diagram 600 which supports techniques for reducing distortion in an FRD in accordance with various aspects of the present disclosure. As depicted in FIG. 6, the data path diagram 600 may include one or more of an AP 602, a MIPI RX 604, an FRD 606, a partial frame memory 608, a CAC 610, a Mura compensation 612, a digital gamma 614, a source out 616, a gate signal 618, a panel 620, and/or other components.

The AP 602 may serve as the processing unit that executes instructions for rendering images in an FRD. In some implementations, the AP 602 may be responsible for the overall management of image processing tasks. The AP 602 may interact with other components to coordinate the rendering process.

The MIPI RX 604 may function as the interface for receiving multimedia data in the data path diagram. In some implementations, the MIPI RX 604 may facilitate the transfer of data from external sources to the data path diagram 600. The MIPI RX 604 may be compatible with various multimedia data formats.

The FRD 606 may be responsible for managing the foveated rendering aspects within the display system. In some implementations, the FRD 606 may selectively render areas of the display based on the user's gaze. The FRD 606 may adjust rendering parameters in real-time.

The partial frame memory 608 may store sections of frame data for processing in the data path diagram. In some implementations, the partial frame memory 608 may temporarily hold data during the image rendering process. The partial frame memory 608 may be accessed by other components for data retrieval.

The CAC 610 may perform chromatic aberration corrections to minimize color distortions in the display. In some implementations, the CAC 610 may adjust color channels to align them correctly on the display.

The Mura compensation 612 may adjust for variations in luminance across the display panel. In some implementations, the Mura compensation 612 may even out the brightness levels to create a uniform appearance. The Mura compensation 612 may be applied to different regions of the display.

The digital gamma 614 may control the luminance levels of the display for accurate image representation. In some implementations, the digital gamma 614 may modify the gamma curve settings to match the display characteristics. The digital gamma 614 may influence the overall visual quality of the display.

The source out 616 may provide the processed image data for display output. In some implementations, the source out 616 may act as the final stage before the image is presented on the panel 620. The source out 616 may format the data to be compatible with the display technology used.

The gate signal 618 may regulate the timing of line scanning in the display panel. In some implementations, the gate signal 618 may synchronize the scanning process with the refresh rate of the panel 620. The gate signal 618 may facilitate maintaining the display's visual integrity.

The panel 620 may serve as the actual display surface where the images are rendered for the user. In some implementations, the panel 620 may include various types of display technologies, such as LCD or OLED. The panel 620 may be the interface through which the user interacts with the virtual environment.

In some implementations, the AP 602 may send downscaled images to the MIPI RX 604, which may then transfer the data to the FRD 606. The FRD 606 may process the data and store sections in the partial frame memory 608. The CAC 610 may then perform chromatic aberration corrections. The Mura compensation 612 may adjust luminance variations. The digital gamma 614 may control luminance levels, and the source out 616 may provide the final image data for display on the panel 620. The gate signal 618 may regulate the timing of line scanning, ensuring synchronization with the panel 620's refresh rate.

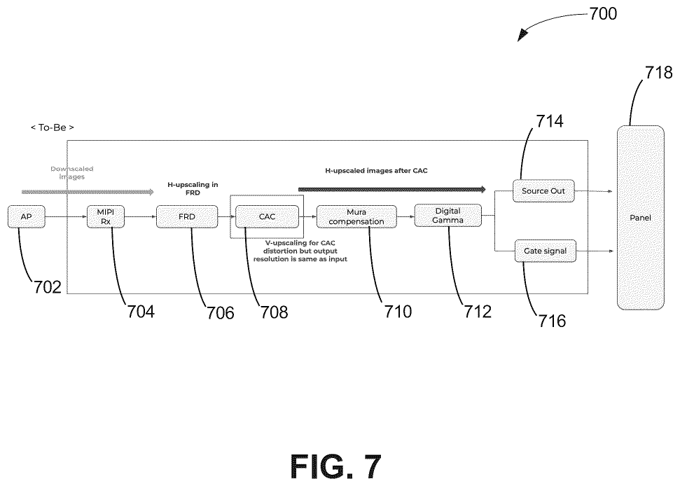

FIG. 7 shows a data path diagram 700 which supports techniques for reducing distortion in an FRD in accordance with various aspects of the present disclosure. As depicted in FIG. 7, the data path diagram 700 may include one or more of an AP 702, a MIPI RX 704, an FRD 706, a CAC 708, a Mura compensation 710, a digital gamma 712, a source out 714, a gate signal 716, a panel 718, and/or other components.

The AP 702 may include processing unit. The AP 702 may be responsible for executing instructions that affect the rendering of images. The AP 702 may interact with other components to process multimedia content. The MIPI RX 704 may function as the receiver for multimedia data in the data path diagram 700. The FRD 706 may act as the component responsible for foveated rendering in the data path diagram 700. The CAC 708 may perform chromatic aberration corrections within the data path diagram 700. The Mura compensation 710 may address uniformity issues across the display in the data path diagram 700. The digital gamma 712 may adjust the gamma curve for the display in the data path diagram 700. The source out 714 may provide the output video data stream in the data path diagram 700. The gate signal 716 may control the timing of pixel activation in the data path diagram 700. The panel 718 may include an array of pixels that illuminate to form the final image. The panel 718 may receive processed data from the source out 714 for display to the user.

In some implementations, the AP 702 may send downscaled images to the MIPI RX 704, which may then pass the data to the FRD 706 for horizontal upscaling. The CAC 708 may perform vertical upscaling to correct chromatic aberration before the data is sent to the Mura compensation 710. The digital gamma 712 may adjust the gamma curve before the source out 714 sends the final video data to the panel 718. The gate signal 716 may synchronize the display refresh with the incoming video data to ensure proper timing of pixel activation.

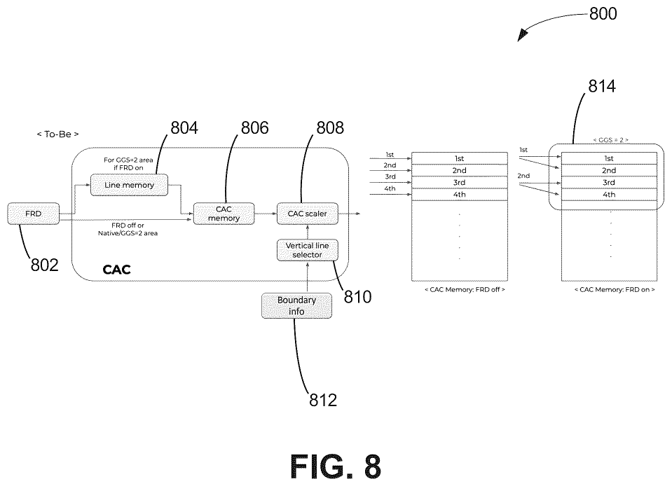

FIG. 8 shows a distortion resolution diagram 800 which supports techniques for reducing distortion in an FRD in accordance with various aspects of the present disclosure. As depicted in FIG. 8, the distortion resolution diagram 800 may include one or more of an FRD 802, a line memory 804, a CAC memory 806, a CAC scaler 808, a vertical line selector 810, a boundary info 812, a GGS=2 814, and/or other components.

The FRD 802 may represent the foveated resolution display component within the distortion resolution diagram. The FRD 802 may be configured to display images where the resolution varies across the visual field. The FRD 802 may selectively render areas of the visual field with higher resolution where the user's gaze is focused.

The line memory 804 may include storage for maintaining line-specific data used in the distortion resolution process. The line memory 804 may store information that corresponds to individual lines of the display. The line memory 804 may be accessed to retrieve data for processing by other components in the distortion resolution diagram 800.

The CAC memory 806 may serve as a dedicated storage area for chromatic aberration correction data. The CAC memory 806 may hold information necessary for adjusting the color fringing that can occur in displays. The CAC memory 806 may be utilized by the CAC scaler 808 to access correction data during the scaling process.

The CAC scaler 808 may be responsible for scaling operations related to chromatic aberration correction within the distortion resolution diagram. The CAC scaler 808 may adjust the size of color components in an image to counteract chromatic aberration. The CAC scaler 808 may work in conjunction with the vertical line selector 810 to apply scaling to selected lines.

The vertical line selector 810 may allow for the selection of specific vertical lines for processing in the distortion resolution diagram. The vertical line selector 810 may enable the choice of lines based on criteria such as their location in the foveated region. The vertical line selector 810 may interact with the line memory 804 to determine which lines to process.

The boundary info 812 may provide information regarding the boundaries of different regions within the distortion resolution diagram. The boundary info 812 may indicate where the foveated region ends and the peripheral region begins. The boundary info 812 may be used by the vertical line selector 810 to make decisions about line selection.

The GGS=2 814 may indicate a grouped gate scan setting used in the distortion resolution diagram. The GGS=2 814 may refer to a mode where each line of pixels is duplicated to create a larger image area. The GGS=2 814 may be applied to regions of the display outside the foveated area to reduce the resolution and processing requirements.

In some implementations, the FRD 802 may be connected to the line memory 804 to store line-specific data for the foveated resolution display. The line memory 804 may then interface with the CAC memory 806 to store chromatic aberration correction data. The CAC scaler 808 may access the CAC memory 806 to perform scaling operations and may work with the vertical line selector 810 to determine which lines to process based on the boundary info 812. The GGS=2 814 may be used to duplicate lines in regions outside the foveated area, ensuring consistent image quality across the display.

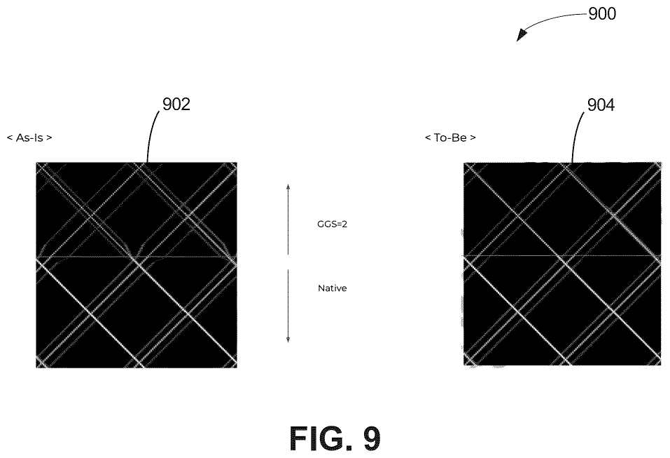

FIG. 9 shows distortion comparison images 900 which supports techniques for reducing distortion in an FRD in accordance with various aspects of the present disclosure. As depicted in FIG. 9, the distortion comparison images 900 may include as-is rendering 902 and to-be rendering 904. In as-is rendering 902, distortion may be visible with GGS=2, but not native. No distortion may be visible in to-be rendering 904.

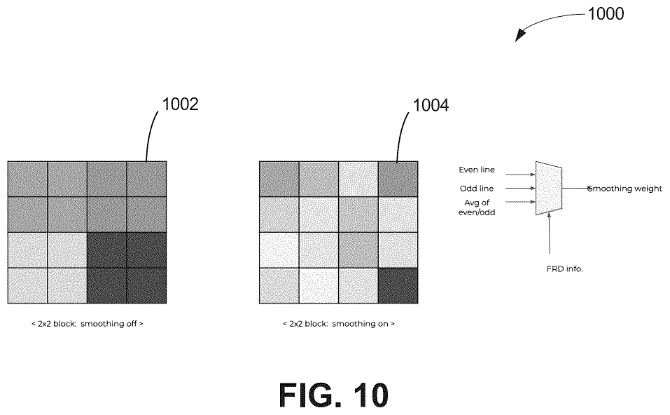

FIG. 10 shows distortion comparison images 1000 which supports techniques for reducing distortion in an FRD in accordance with various aspects of the present disclosure. As depicted in FIG. 10, the distortion comparison images 1000 may include one or more of a smoothing off grid 1002 and smoothing on grid 1004. Pixels may be smoothed based on a smoothing weight. The smoothing weight may be determined based on an even line, an odd line, and average of the even and odd lines, FRD information, and/or other information.

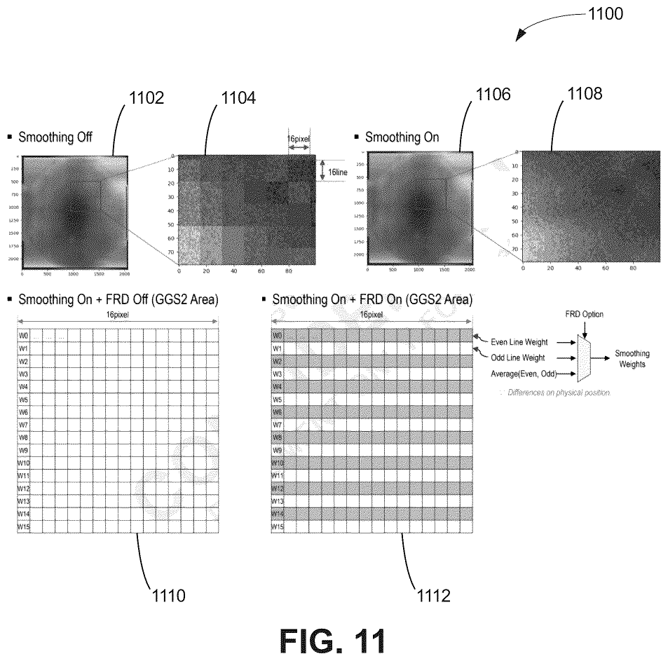

FIG. 11 shows distortion comparison images 1100 which supports techniques for reducing distortion in an FRD in accordance with various aspects of the present disclosure. As depicted in FIG. 11, the distortion comparison images 1100 may include one or more of a smoothing off grid 1102, a smoothing off inset 1104, a smoothing on grid 1106, a smoothing on inset 1108, a smoothing on and FRD off grid 1110, and a smoothing on and FRD on grid 1112.

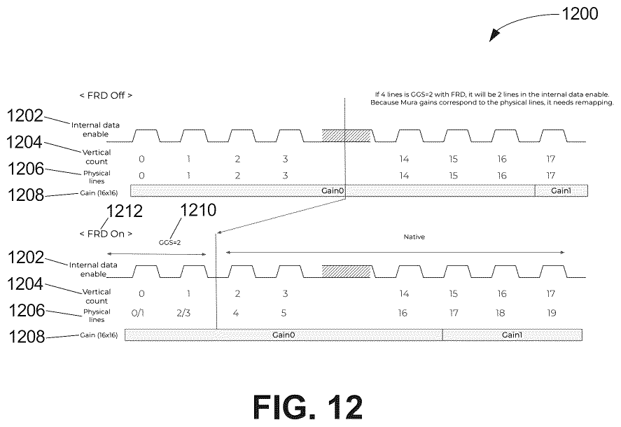

FIG. 12 shows a gain remapping diagram 1200 which supports techniques for reducing distortion in an FRD in accordance with various aspects of the present disclosure. As depicted in FIG. 12, the gain remapping diagram 1200 may include one or more of an internal data enable 1202, a vertical count 1204, physical lines 1206, a gain (16×16) 1208, a GGS=2 1210, a FRD 1212, and/or other components.

The internal data enable 1202 may represent a control mechanism that activates the processing of image data within the display system. In some implementations, the internal data enable 1202 may be a trigger that initiates the adjustment of image attributes. The internal data enable 1202 may function as a switch that determines when the image processing should commence. The internal data enable 1202 may be associated with a variety of image processing techniques.

The vertical count 1204 may indicate the number of vertical lines or rows that are processed in the display system. In some implementations, the vertical count 1204 may serve as an index for navigating through the vertical axis of the display. The vertical count 1204 may provide a reference for aligning image data with the corresponding display pixels. The vertical count 1204 may be utilized in conjunction with horizontal parameters to define the overall grid of the display.

The physical lines 1206 may correspond to the actual lines of pixels that are displayed on the screen. In some implementations, the physical lines 1206 may form the visual content that users perceive on the display. The physical lines 1206 may be composed of individual pixels that collectively create the image. The physical lines 1206 may vary in number depending on the resolution and dimensions of the display.

The gain (16×16) 1208 may refer to the amplification factor applied to the pixel data to adjust the brightness of the display. In some implementations, the gain (16×16) 1208 may modulate the intensity of the light emitted by each pixel. The gain (16×16) 1208 may be applied uniformly across the display or vary per pixel. The gain (16×16) 1208 may influence the contrast and visibility of the displayed image.

The GGS=2 1210 may indicate a grouped gate scan mode where each line of pixels is duplicated to enhance the resolution. In some implementations, the GGS=2 1210 may be a method for increasing the pixel density in certain areas of the display. The GGS=2 1210 may involve the replication of pixel lines to create a more detailed visual output. The GGS=2 1210 may be selectively applied to specific regions of the display to create a foveated effect.

The FRD 1212 may denote the foveated resolution display mode that selectively renders areas of the display with higher resolution based on the user's gaze. In some implementations, the FRD 1212 may adjust the rendering resolution in response to eye-tracking data. The FRD 1212 may concentrate processing power on the areas of the display that are most relevant to the user's current focus. The FRD 1212 may be part of a system that aims to deliver high-resolution visuals where they are most needed on the display.

In some implementations, the internal data enable 1202 may be arranged to control the activation of the vertical count 1204 and the processing of physical lines 1206. The vertical count 1204 may be used to navigate through the physical lines 1206, determining the specific lines that are processed and displayed.

In some implementations, the gain (16×16) 1208 may be applied to the physical lines 1206 to adjust their brightness, with the GGS=2 1210 mode duplicating these lines to enhance resolution. The FRD 1212 may selectively enable higher resolution rendering for specific areas of the display, based on the user's gaze, by adjusting the internal data enable 1202 and the vertical count 1204.

The disclosed system(s) address a problem in traditional electronic display techniques tied to computer technology, namely, the technical problem of image distortion and color inaccuracies in flexible, foldable, and/or other display devices. The disclosed system solves this technical problem by providing a solution also rooted in computer technology, namely, by providing for reducing distortion in an FRD. The disclosed subject technology further provides improvements to the functioning of the computer itself because it improves processing and efficiency in display technologies.

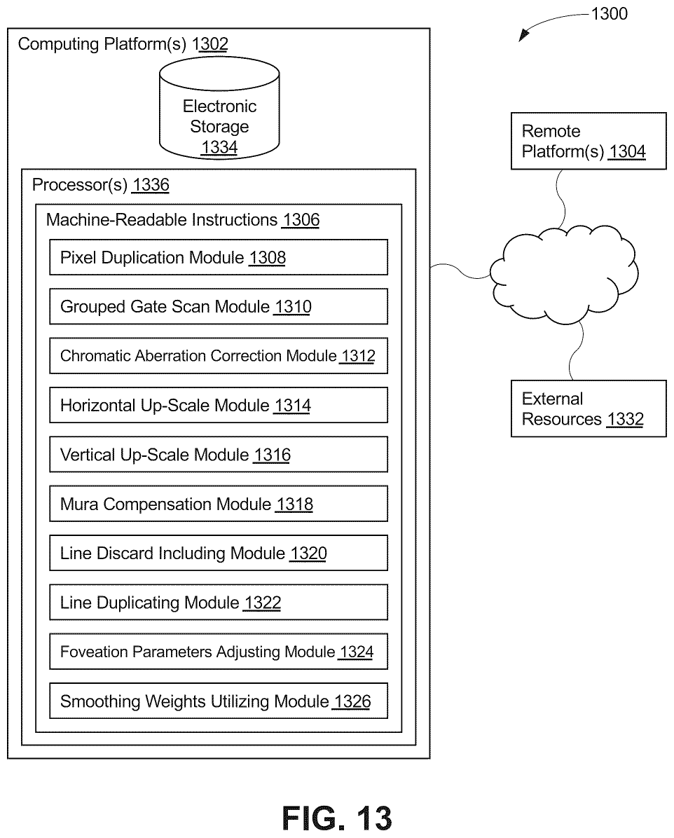

FIG. 13 illustrates a system 1300 configured for reducing distortion in an FRD, according to certain aspects of the disclosure. In some embodiments, system 1300 may include one or more computing platforms 1302. Computing platform(s) 1302 may be configured to communicate with one or more remote platforms 1304 according to a client/server architecture, a peer-to-peer architecture, and/or other architectures. Remote platform(s) 1304 may be configured to communicate with other remote platforms via computing platform(s) 1302 and/or according to a client/server architecture, a peer-to-peer architecture, and/or other architectures. Users may access system 1300 via remote platform(s) 1304.

Computing platform(s) 1302 may be configured by machine-readable instructions 1306. Machine-readable instructions 1306 may include one or more instruction modules. The instruction modules may include computer program modules. The instruction modules may include one or more of a pixel duplication module 1308, grouped gate scan module 1310, chromatic aberration correction module 1312, horizontal up-scale module 1314, vertical up-scale module 1316, Mura compensation module 1318, line discard including module 1320, line duplicating module 1322, foveation parameters adjusting module 1324, line discard including module 1326, smoothing weights utilizing module 1328, and/or other modules.

Pixel duplication module 1308 may be configured to implement a pixel duplication for a select region of a display.

Grouped gate scan module 1310 may be configured to implement a horizontal upscaling and a vertical upscaling through the grouped gate scan (GGS).

Chromatic aberration correction module 1312 may be configured to implement a chromatic aberration correction (CAC) to the select region. Implementing the chromatic aberration correction may include implementing a scaler configured to include a line discard with an upscaling or a downscaling.

Horizontal up-scale module 1314 may be configured to implement a horizontal up-scale of the select region in response to the CAC.

Vertical up-scale module 1316 may be configured to implement a vertical up-scale of the select region in response to the CAC.

Mura compensation module 1318 may be configured to implement a Mura compensation to the select region.

Line discard including module 1320 may be configured to include a line discard with an upscaling or a downscaling to address differences on physical position between the native pixel and the upscaled pixels.

Line duplicating module 1322 may be configured to duplicate, in response to FRD being enabled, each line of a horizontally upscaled frame before writing to CAC memory.

Foveation parameters adjusting module 1324 may be configured to adjust foveation parameters such that the native resolution is maintained in the foveated downscaled frame.

Smoothing weights utilizing module 1326 may be configured to utilize, in response to FRD information indicating whether FRD is on or off, smoothing weights to adjust gain across physical lines.

In some embodiments, computing platform(s) 1302, remote platform(s) 1304, and/or external resources 1332 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1302, remote platform(s) 1304, and/or external resources 1332 may be operatively linked via some other communication media.

A given remote platform 1304 may include one or more processors configured to execute computer program modules. The computer program modules may be configured to enable an expert or user associated with the given remote platform 1304 to interface with system 1300 and/or external resources 1332, and/or provide other functionality attributed herein to remote platform(s) 1304. By way of non-limiting example, a given remote platform 1304 and/or a given computing platform 1302 may include one or more of a server, a desktop computer, a laptop computer, a handheld computer, a tablet computing platform, a NetBook, a Smartphone, a gaming console, and/or other computing platforms.

External resources 1332 may include sources of information outside of system 1300, external entities participating with system 1300, and/or other resources. In some embodiments, some or all of the functionality attributed herein to external resources 1332 may be provided by resources included in system 1300.

Computing platform(s) 1302 may include electronic storage 1334, one or more processors 1336, and/or other components. Computing platform(s) 1302 may include communication lines, or ports to enable the exchange of information with a network and/or other computing platforms. Illustration of computing platform(s) 1302 in FIG. 13 is not intended to be limiting. Computing platform(s) 1302 may include a plurality of hardware, software, and/or firmware components operating together to provide the functionality attributed herein to computing platform(s) 1302. For example, computing platform(s) 1302 may be implemented by a cloud of computing platforms operating together as computing platform(s) 1302.

Electronic storage 1334 may comprise non-transitory storage media that electronically stores information. The electronic storage media of electronic storage 1334 may include one or both of system storage that is provided integrally (i.e., substantially non-removable) with computing platform(s) 1302 and/or removable storage that is removably connectable to computing platform(s) 1302 via, for example, a port (e.g., a USB port, a firewire port, etc.) or a drive (e.g., a disk drive, etc.). Electronic storage 1334 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1334 may include one or more virtual storage resources (e.g., cloud storage, a virtual private network, and/or other virtual storage resources). Electronic storage 1334 may store software algorithms, information determined by processor(s) 1336, information received from computing platform(s) 1302, information received from remote platform(s) 1304, and/or other information that enables computing platform(s) 1302 to function as described herein.

Processor(s) 1336 may be configured to provide information processing capabilities in computing platform(s) 1302. As such, processor(s) 1336 may include one or more of a digital processor, an analog processor, a digital circuit designed to process information, an analog circuit designed to process information, a state machine, and/or other mechanisms for electronically processing information. Although processor(s) 1336 is shown in FIG. 13 as a single entity, this is for illustrative purposes only. In some embodiments, processor(s) 1336 may include a plurality of processing units. These processing units may be physically located within the same device, or processor(s) 1336 may represent processing functionality of a plurality of devices operating in coordination. Processor(s) 1336 may be configured to execute modules 1308, 1310, 1312, 1314, 1316, 1318, 1320, 1322, 1324, and/or 1326, and/or other modules. Processor(s) 1336 may be configured to execute modules 1308, 1310, 1312, 1314, 1316, 1318, 1320, 1322, 1324, and/or 1326, and/or other modules by software; hardware; firmware; some combination of software, hardware, and/or firmware; and/or other mechanisms for configuring processing capabilities on processor(s) 1336. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1308, 1310, 1312, 1314, 1316, 1318, 1320, 1322, 1324, and/or 1326 are illustrated in FIG. 13 as being implemented within a single processing unit, in embodiments in which processor(s) 1336 includes multiple processing units, one or more of modules 1308, 1310, 1312, 1314, 1316, 1318, 1320, 1322, 1324, and/or 1326 may be implemented remotely from the other modules. The description of the functionality provided by the different modules 1308, 1310, 1312, 1314, 1316, 1318, 1320, 1322, 1324, and/or 1326 described below is for illustrative purposes, and is not intended to be limiting, as any of modules 1308, 1310, 1312, 1314, 1316, 1318, 1320, 1322, 1324, and/or 1326 may provide more or less functionality than is described. For example, one or more of modules 1308, 1310, 1312, 1314, 1316, 1318, 1320, 1322, 1324, and/or 1326 may be eliminated, and some or all of its functionality may be provided by other ones of modules 1308, 1310, 1312, 1314, 1316, 1318, 1320, 1322, 1324, and/or 1326. As another example, processor(s) 1336 may be configured to execute one or more additional modules that may perform some or all of the functionality attributed below to one of modules 1308, 1310, 1312, 1314, 1316, 1318, 1320, 1322, 1324, and/or 1326.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

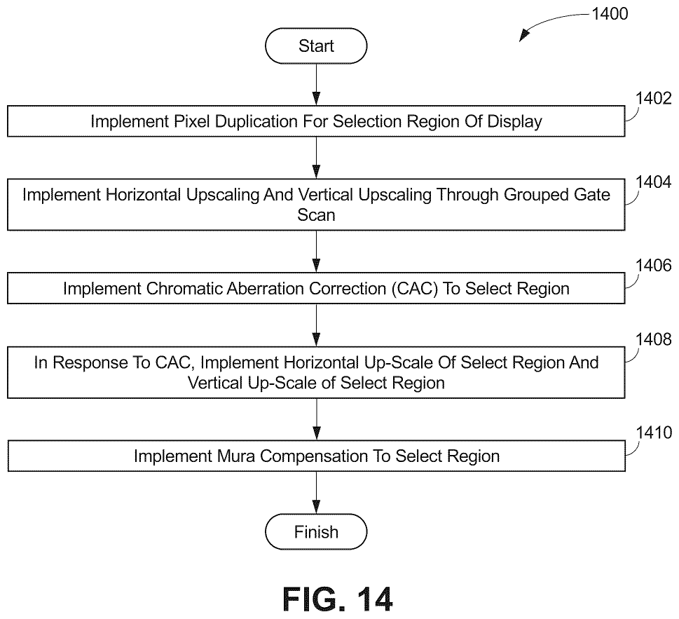

FIG. 14 illustrates an example flow diagram (e.g., process 1400) for reducing distortion in an FRD, according to certain aspects of the disclosure. For explanatory purposes, the example process 1400 is described herein with reference to FIGS. 1-13. Further for explanatory purposes, the steps of the example process 1400 are described herein as occurring in serial, or linearly. However, multiple instances of the example process 1400 may occur in parallel. For purposes of explanation of the subject technology, the process 1400 will be discussed in reference to FIGS. 1-13.

An operation 1402 may include implementing a pixel duplication for a select region of a display. Operation 1402 may be performed by one or more hardware processors configured by machine-readable instructions including a module that is the same as or similar to pixel duplication module 1308, in accordance with one or more embodiments.

An operation 1404 may include implementing a horizontal upscaling and a vertical upscaling through the grouped gate scan (GGS). Operation 1404 may be performed by one or more hardware processors configured by machine-readable instructions including a module that is the same as or similar to grouped gate scan module 1310, in accordance with one or more embodiments.

An operation 1406 may include implementing a chromatic aberration correction (CAC) to the select region. Operation 1406 may be performed by one or more hardware processors configured by machine-readable instructions including a module that is the same as or similar to chromatic aberration correction module 1312, in accordance with one or more embodiments.

An operation 1408 may include, in response to the CAC, implementing a horizontal up-scale of the select region and a vertical up-scale of the select region. Operation 1408 may be performed by one or more hardware processors configured by machine-readable instructions including a module that is the same as or similar to horizontal up-scale module 1314 and vertical up-scale module 1316, in accordance with one or more embodiments.

An operation 1410 may include implementing a Mura compensation to the select region. Operation 1410 may be performed by one or more hardware processors configured by machine-readable instructions including a module that is the same as or similar to Mura compensation module 1318, in accordance with one or more embodiments.

According to an aspect, implementing the chromatic aberration correction comprises implementing a scaler configured to include a line discard with an upscaling or a downscaling.

According to an aspect, the process 1400 may include selecting between an even line and an odd line based on boundary info, wherein the selection is integrated within the CAC to support fine tuning of the displayed image.

According to an aspect, the process 1400 may include duplicating, in response to FRD being enabled, each line of a horizontally upscaled frame before writing to CAC memory.

According to an aspect, the process 1400 may include adjusting foveation parameters such that the native resolution is maintained in the foveated downscaled frame.

According to an aspect, the process 1400 may comprise including a line discard with an upscaling or a downscaling to address differences on physical position between the native pixel and the upscaled pixels.

According to an aspect, the process 1400 may include utilizing, in response to FRD information indicating whether FRD is on or off, smoothing weights to adjust gain across physical lines.

According to an aspect, the pixel duplication is implemented in a region where v resolution equals ½, to maintain the original resolution in the displayed image.

According to an aspect, the horizontal upscaling and the vertical upscaling through the GGS are synchronized with frame synced register settings to ensure consistency in the displayed image.

According to an aspect, the Mura compensation includes a vertical line selector to adjust gain based on the vertical count, enhancing uniformity in the displayed image.

According to an aspect, the CAC further comprises a v-line duplication block, configured to duplicate lines in response to FRD information for GGS equals 2 areas.

According to an aspect, the horizontal upscaling is performed using raster-aligned compression to match the intended full size frame with minimal distortion.

According to an aspect, the vertical upscaling is performed by panel gate driver circuits that support GGS, ensuring the v-upscaled images after CAC match the foveated downscaled frame.

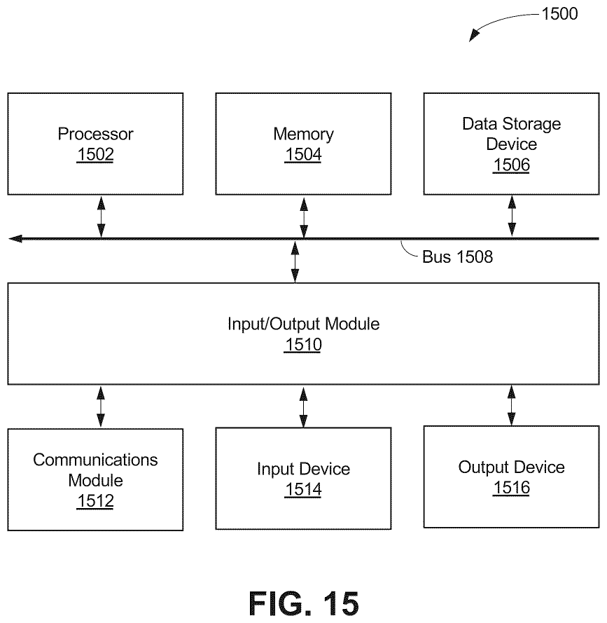

FIG. 15 is a block diagram illustrating an exemplary computer system 1500 with which aspects of the subject technology can be implemented. In certain aspects, the computer system 1500 may be implemented using hardware or a combination of software and hardware, either in a dedicated server, integrated into another entity, or distributed across multiple entities.

Computer system 1500 (e.g., server and/or client) includes a bus 1508 or other communication mechanism for communicating information, and a processor 1502 coupled with bus 1508 for processing information. By way of example, the computer system 1500 may be implemented with one or more processors 1502. Processor 1502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1500 can include, in addition to hardware, code that creates an execution environment for the computer program in question, e.g., code that constitutes processor firmware, a protocol stack, a database management system, an operating system, or a combination of one or more of them stored in an included memory 1504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1508 for storing information and instructions to be executed by processor 1502. The processor 1502 and the memory 1504 can be supplemented by, or incorporated in, special purpose logic circuitry.

The instructions may be stored in the memory 1504 and implemented in one or more computer program products, i.e., one or more modules of computer program instructions encoded on a computer-readable medium for execution by, or to control the operation of, the computer system 1500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1504 may also be used for storing temporary variable or other intermediate information during execution of instructions to be executed by processor 1502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1500 further includes a data storage device 1506 such as a magnetic disk or optical disk, coupled to bus 1508 for storing information and instructions. Computer system 1500 may be coupled via input/output module 1510 to various devices. The input/output module 1510 can be any input/output module. Exemplary input/output modules 1510 include data ports such as USB ports. The input/output module 1510 is configured to connect to a communications module 1512. Exemplary communications modules 1512 include networking interface cards, such as Ethernet cards and modems. In certain aspects, the input/output module 1510 is configured to connect to a plurality of devices, such as an input device 1514 and/or an output device 1516. Exemplary input devices 1514 include a keyboard and a pointing device, e.g., a mouse or a trackball, by which a user can provide input to the computer system 1500. Other kinds of input devices 1514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1516 include display devices such as an LCD (liquid crystal display) monitor, for displaying information to the user.

According to one aspect of the present disclosure, the above-described gaming systems can be implemented using a computer system 1500 in response to processor 1502 executing one or more sequences of one or more instructions contained in memory 1504. Such instructions may be read into memory 1504 from another machine-readable medium, such as data storage device 1506. Execution of the sequences of instructions contained in the main memory 1504 causes processor 1502 to perform the process steps described herein. One or more processors in a multi-processing arrangement may also be employed to execute the sequences of instructions contained in memory 1504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1500 can include clients and servers. A client and server are generally remote from each other and typically interact through a communication network. The relationship of client and server arises by virtue of computer programs running on the respective computers and having a client-server relationship to each other. Computer system 1500 can be, for example, and without limitation, a desktop computer, laptop computer, or tablet computer. Computer system 1500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1502 for execution. Such a medium may take many forms, including, but not limited to, non-volatile media, volatile media, and transmission media. Non-volatile media include, for example, optical or magnetic disks, such as data storage device 1506. Volatile media include dynamic memory, such as memory 1504. Transmission media include coaxial cables, copper wire, and fiber optics, including the wires that comprise bus 1508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1500 reads game data and provides a game, information may be read from the game data and stored in a memory device, such as the memory 1504. Additionally, data from the memory 1504 servers accessed via a network the bus 1508, or the data storage 1506 may be read and loaded into the memory 1504. Although data is described as being found in the memory 1504, it will be understood that data does not have to be stored in the memory 1504 and may be stored in other memory accessible to the processor 1502 or distributed among several media, such as the data storage 1506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method to reduce distortion in a foveated resolution display (FRD), the method comprising:
implementing a pixel duplication for a select region of a display;
implementing a horizontal upscaling and a vertical upscaling through a grouped gate scan (GGS);
implementing a chromatic aberration correction (CAC) to the select region;
in response to the CAC, implementing a horizontal up-scale of the select region and a vertical up-scale of the select region; and
implementing a Mura compensation to the select region.

2. The method of claim 1, wherein implementing the CAC comprises implementing a scaler configured to include a line discard with an upscaling or a downscaling.

3. The method of claim 1, further comprising selecting between an even line and an odd line based on boundary info, wherein the selection is integrated within a CAC to support fine tuning of a displayed image.

4. The method of claim 1, further comprising duplicating, in response to FRD being enabled, each line of a horizontally upscaled frame before writing to CAC memory.

5. The method of claim 1, further comprising adjusting foveation parameters such that a native resolution is maintained in a foveated downscaled frame.

6. The method of claim 1, further comprising including a line discard with an upscaling or a downscaling to address differences on physical position between a native pixel and an upscaled pixels.

7. The method of claim 1, further comprising utilizing, in response to FRD information indicating whether FRD is on or off, smoothing weights to adjust gain across physical lines.

8. The method of claim 1, wherein the pixel duplication is implemented in a region where v resolution equals ½, to maintain the original resolution in a displayed image.

9. The method of claim 1, wherein the horizontal upscaling and the vertical upscaling through the GGS are synchronized with frame synced register settings to ensure consistency in a displayed image.

10. The method of claim 1, wherein the Mura compensation includes a vertical line selector to adjust gain based on the vertical count, enhancing uniformity in a displayed image.

11. The method of claim 1, wherein a CAC further comprises a vertical line duplication block, configured to duplicate lines in response to FRD information for GGS equals 2 areas.

12. The method of claim 1, wherein the horizontal upscaling is performed using raster-aligned compression to match an intended full size frame with minimal distortion.

13. The method of claim 1, wherein the vertical upscaling is performed by panel gate driver circuits that support GGS, ensuring v-upscaled images after CAC match a foveated downscaled frame.

14. A system configured for reducing distortion in a foveated resolution display (FRD), the system comprising:
a non-transient computer-readable storage medium having executable instructions embodied thereon; and
one or more hardware processors configured to execute the instructions to:
implement a pixel duplication for a select region of a display;
implement a horizontal upscaling and a vertical upscaling through a grouped gate scan (GGS);
implement a chromatic aberration correction (CAC) to the select region;
in response to the CAC, implement a horizontal up-scale of the select region and a vertical up-scale of the select region; and
implement a Mura compensation to the select region.

15. The system of claim 14, wherein implementing the chromatic aberration correction comprises implementing a scaler configured to include a line discard with an upscaling or a downscaling.

16. The system of claim 14, wherein the one or more hardware processors are further configured by the instructions to:
select between an even line and an odd line based on boundary info, wherein the selection is integrated within a CAC to support fine tuning of a displayed image.

17. The system of claim 14, wherein the one or more hardware processors are further configured by the instructions to:
duplicate, in response to FRD being enabled, each line of a horizontally upscaled frame before writing to CAC memory.

18. The system of claim 14, wherein the one or more hardware processors are further configured by the instructions to:
adjust foveation parameters such that a native resolution is maintained in a DSC foveated downscaled frame.

19. The system of claim 14, wherein the one or more hardware processors are further configured by the instructions to:
include a line discard with an upscaling or a downscaling to address differences on physical position between a native pixel and an upscaled pixels.

20. A non-transient computer-readable storage medium having instructions embodied thereon, the instructions being executable by one or more processors to perform a method of reducing distortion in a foveated resolution display (FRD), the method comprising:
implementing a pixel duplication for a select region of a display;
implementing a horizontal upscaling and a vertical upscaling through a grouped gate scan (GGS);
implementing a chromatic aberration correction (CAC) to the select region;
in response to the CAC, implementing a horizontal up-scale of the select region and a vertical up-scale of the select region; and
implementing a Mura compensation to the select region.
